(19) United States
(12) Patent Application Publication
(10) Pub. No.: US 2007/0279910 A1
(43) Pub. Date: Dec. 6, 2007

(54) Illumination device

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/806,504

(22) Filed: May 31, 2007

(30) Foreign Application Priority Data
Jun. 2, 2006 (TW) 095119780

(51) Int. Cl. F21V 7/00

(52) U.S. Cl. 362/298; 362/235; 362/247

(57) ABSTRACT

An illumination device includes a reflective cover, at least one light emitting diode (LED), a first electrical conductive body and a second electrical conductive body. The reflective cover has an opening, and the LED is disposed therein. The first ends of the first electrical conductive body and the second electrical conductive body are respectively electrically connected to the LED.

### CROSS REFERENCE TO RELATED APPLICATIONS

This Non-provisional application claims priority under 35 U.S.C. §119(a) on Patent Application No(s). 095119780 filed in Taiwan, Republic of China on Jun. 2, 2006, the entire contents of which are hereby incorporated by reference.

### BACKGROUND OF THE INVENTION

1. Field of Invention

The invention relates to an illumination device and, in particular, to an illumination device using light emitting diodes as its light sources.

2. Related Art

The light emitting diode (LED) is made of semiconductor materials. The LED has two electrode terminals. When a small voltage is imposed to the electrode terminals, energy is released in the form of light through the combinations of electrons and holes.

The manufacturing processes and materials of the LED have been continuously improved in recent years to enhance the light-emitting efficiency thereof. Unlike the usual incandescent lamp, the LED involves cold light emissions and thus has the advantages of low power consumption, long device lifetime, no warm-up time, and fast response. Its applications include normal displays, indicators, as well as illumination nowadays. For example, the LED is used in flashlights, illumination devices in the headlights of vehicles, and indoor illumination.

Please refer to FIGS. 1 and 2. FIG. 2 shows a schematic cross section of an LED disposed on a circuit board. The conventional LED illumination device 1 includes a lamp base 11, a circuit board 12, a plurality of LEDs 13, a plurality of lenses 14, and a heat-dissipating device 15.

The lamp base 11 is fixed on the heat-dissipating device 15. The circuit board 12 drives the LEDs 13 to emit light. The circuit board 12 is disposed inside the lamp base 11. The LEDs 13 are disposed on the circuit board 12. Each of the lenses 14 is fixed above the corresponding LED 13 by using a fixing component 16 in order to produce better illumination.

Heat dissipation has been a problem for the LEDs 13 as a light source. As the illumination time becomes longer, the temperature of the illumination device 1 increases because the imperfect electro-optical conversion of the LEDs 13. If the heat inside the illumination device 1 is not immediately removed, the light-emitting efficiency of the LEDs 13 will be affected. This may even shorten the lifetime of the LEDs 13. In the prior art, the lamp base 11 is directly fixed on a huge heat-dissipating device 15 to help removing heat produced by the LEDs 13. However, this renders the illumination device 1 a huge volume. In subsequent assembly, the heat-dissipating device 15 may be disposed inside a closed shell. This does not only lower the heat dissipation efficiency, but also affects the light-emitting quality and lifetime of the illumination device 1.

Therefore, it is an important subject to provide an illumination device with good heat dissipation ability.

### SUMMARY OF THE INVENTION

In view of the foregoing, the invention is to provide an illumination device with good heat dissipation ability.

To achieve the above, the invention discloses an illumination device including a reflective cover, at least one light-emitting diode (LED), a first electrical conductive body and a second electrical conductive body. The reflective cover has an opening, and the LED is disposed at the opening. The first electrical conductive body has a first end electrically coupled to the LED. The second electrical conductive body has a first end electrically coupled to the LED.

As mentioned above, in the illumination device of the invention, the LEDs are disposed at the opening of the reflective cover, and the light emitted by the LEDs travels toward the reflective cover. In comparison with the prior art, the invention changes the positions and light-emitting direction of the LEDs. Through the electrical connections between the LEDs and the first and second electrical conductive bodies, the LEDs can be exposed to the air for more direct heat dissipation. This helps stabilizing the light-emitting efficiency and elongating the lifetime of the LEDs. Moreover, the heat fins can be formed on the frame or the reflective cover to help removing heat produced by the LEDs.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of a conventional illumination device;

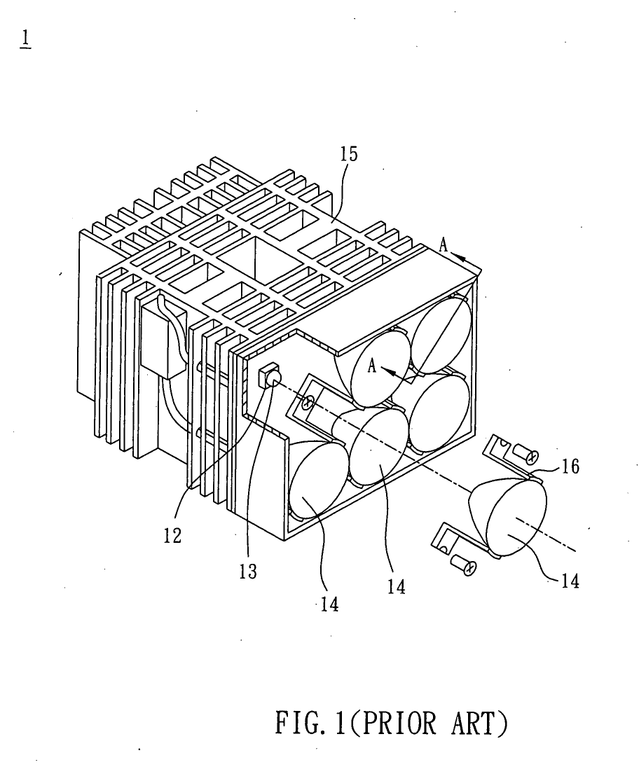

FIG. 2 shows the cross section of the LED and lens along the A-A line in FIG. 1;

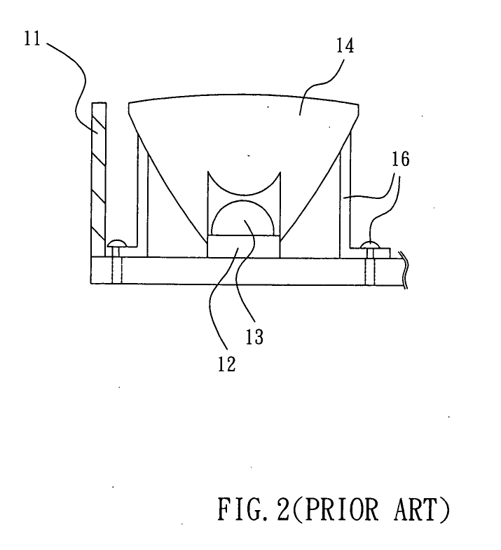

FIG. 3 shows the cross section of an illumination device according to a preferred embodiment of the invention;

FIG. 4 is a bottom view of the illumination device as viewed from an observer; and

FIG. 5 shows a cross section of another illumination device according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

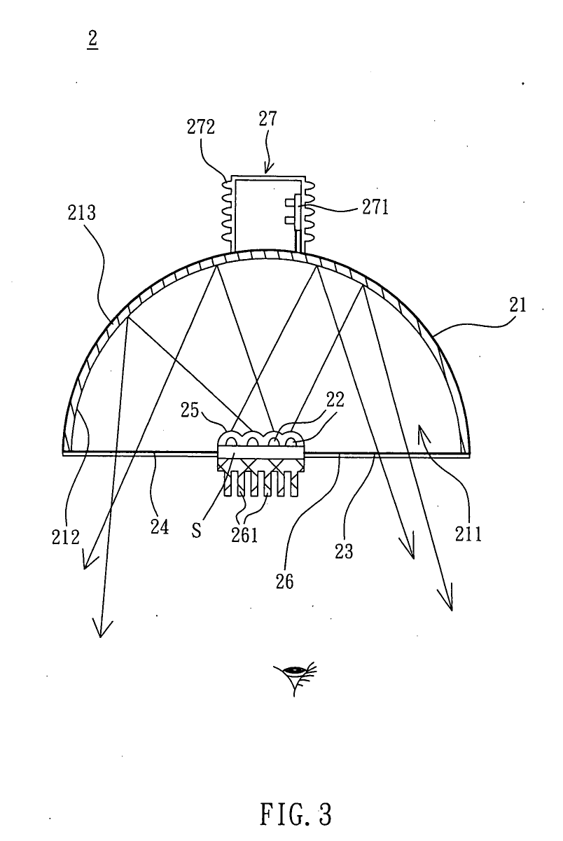

As shown in FIG. 3, an illumination device 2 according to a preferred embodiment of the invention includes a reflective cover 21, at least one LED 22, a first electrical conductive body 23, and a second electrical conductive body 24.

The reflective cover 21 has an opening 211, and the surface of the opening 211 is coated with a reflective layer 212. The reflective layer 212 is a metal or dielectric coating with high reflectivity to reflect light. In addition, the shape of the reflective cover 21 can be designed according to needs. For example, the reflective cover 21 may be designed to have a bowl or cylinder shape. In this embodiment, the cross section of the reflective cover 21 has an arc shape.

The LED 22 is disposed at the opening 211. In addition, the number of the LEDs 22 is not restricted. In this embodiment, there are several LEDs 22 connected in parallel or series and disposed on a circuit substrate S. The light emitted by the LEDs 22 travels toward the reflective cover 21, and the reflective cover 21 then reflects the light.

As shown in FIG. 3, the illumination device 2 may further includes a lens 25. The drawing shows several lenses 25 disposed adjacent to the LEDs 22 to form a lens array. The material of the lenses 25 can be glass or plastic. With the lenses 25, the path of the light emitted by each LED 22 can be changed so that the LEDs 22 disposed at the opening 211 do not block the reflected lights from the reflective cover 21.

A first end of the first electrical conductive body 23 is electrically coupled to the LEDs 22 through, for example, the circuit substrate S. A first end of the second electrical conducive body 24 is also electrically coupled to the LEDs 22 through, for example, the circuit substrate S. However, the first electrical conductive body 23 and the second electrical conductive body 24 are coupled to different electrodes of the LEDs 22. For example, the first electrical conductive body 23 is electrically coupled to the p electrodes of the LEDs 22. The second electrical conductive body 24 is electrically coupled to the n electrodes of the LEDs 22. The first electrical conductive body 23 and the second electrical conductive body 24 can respectively be a metal layer (covered with an insulating protection layer outside) or a wire to achieve the electrical coupling. When an electrical current flows through the first electrical conductive body 23 and the second electrical conductive body 24, the heat produced by the LEDs 22 can be dissipated by air convection as the LEDs 22 are directly exposed to the air instead of combined with a lamp base. This effectively stabilizes the light-emitting efficiency of the LEDs and elongates their lifetime.

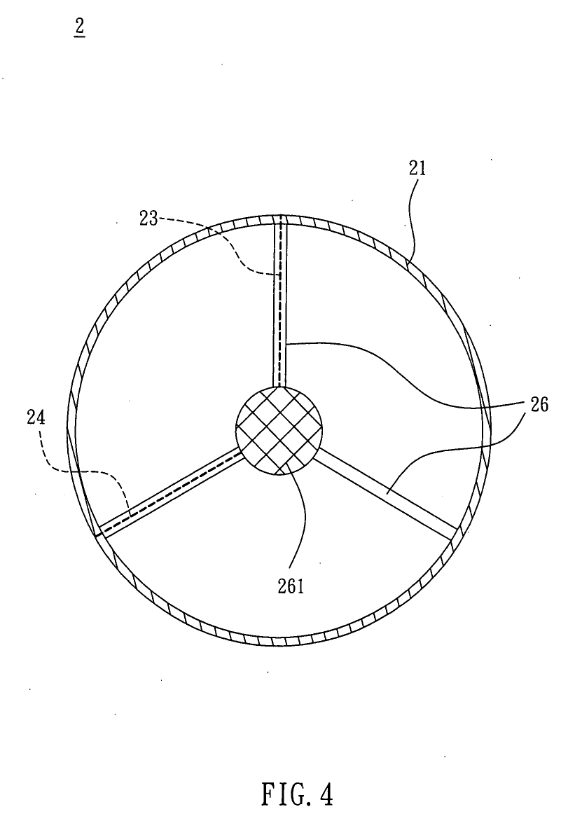

Please refer simultaneously to FIGS. 3 and 4. In this embodiment, the illumination device 2 further includes a frame 26 disposed at the opening 211. The frame 26 supports the circuit substrate S and thus the LEDs 22. The shape of the frame 26 is, for example but not limited to, the structure shown in FIG. 4. Therefore, a second end of the first electrical conductive body 23 can be disposed along the frame 26 to reach an outer surface 213 of the reflective cover 21. A second end of the second electrical conductive body 24 is also disposed along the frame 26 to reach the outer surface 213 of the reflective cover 21.

Moreover, the frame 26 can be made of a thermally conductive material such as a metal. The frame 26 may be formed with several heat fins 261 at the conjunction of the frame 26 and the LEDs 22. The heat fins 261 can be integrally formed (e.g., by stamping) with the trisecting bars of the frame 26. Of course, the heat fins 261 can be manufactured separately and then combined with the frame 26 to enhance heat dissipation of the LEDs 22. Since the LEDs 22 and the heat fins 261 are all exposed to the air, the heat can be readily removed.

As shown in FIG. 3, the illumination device 2 may further include a conversion unit 27 disposed on the outer surface 213 of the reflective cover 21. The conversion unit 27 can accommodate a driving control circuit board 271 of the LEDs 22. The driving control circuit board 271 has at least one converter or a DC-AC inverter for driving the LEDs 22 to emit light. The second ends of the first electrical conductive body 23 and the second electrical conductive body 24 are electrically coupled to the driving control circuit board 271, respectively.

In addition, the conversion unit 27 further includes an electrical conductive connector 272, which has a screw thread. With the electrical conductive connector 272, the illumination device 2 can be fixed and electrically coupled to a lamp base, which is similar to the case of a light bulb.

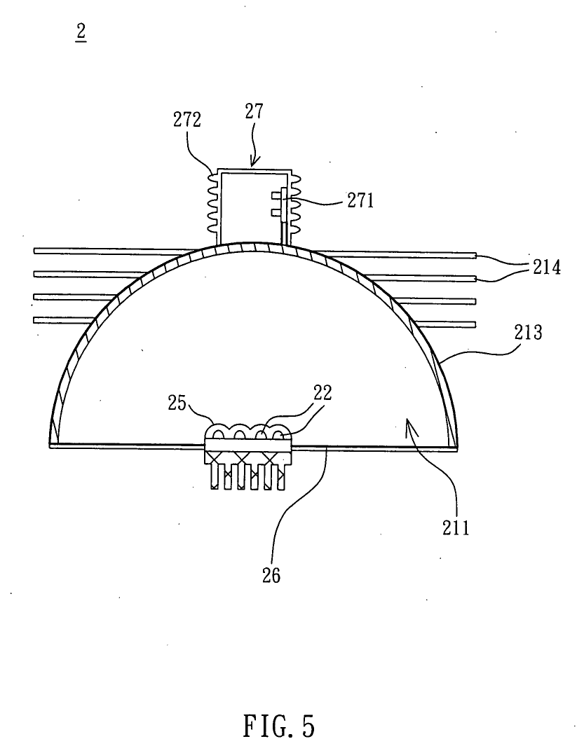

Please refer to FIG. 5. In this embodiment, the reflective cover 21 of the illumination device 2 may include several heat fins 214 disposed on an outer surface 213 of the reflective cover 21 to help dissipating heat.

In summary, in the illumination device of the invention, the LEDs are disposed at the opening of the reflective cover, and the light emitted by the LEDs travels toward the reflective cover. In comparison with the prior art, the invention changes the positions and light-emitting direction of the LEDs. Through the electrical connections between the LEDs and the first and second electrical conductive bodies, the LEDs can be exposed to the air for more direct heat dissipation. This helps stabilizing the light-emitting efficiency and elongating the lifetime of the LEDs. Moreover, the heat fins can be formed on the frame or the reflective cover to help removing heat produced by the LEDs.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An illumination device, comprising:
a reflective cover having an opening;
at least one light-emitting diode (LED) disposed at the opening;
a first electrical conductive body having a first end electrically coupled to the LED; and
a second electrical conductive body having a first end electrically coupled to the LED.

2. The illumination device of claim 1, wherein a surface of the opening of the reflective cover is coated with a reflective layer.

3. The illumination device of claim 1, wherein light emitted from the LED travels towards the reflective cover.

4. The illumination device of claim 1 further comprising:
a frame mounted at the opening for supporting the LED.

5. The illumination device of claim 4, wherein the frame is made of a thermally conductive material and has a plurality of heat fins extending from a junction of the frame and the LED.

6. The illumination device of claim 1 further comprising:
a conversion unit disposed on an outer surface of the reflective cover.

7. The illumination device of claim 6, wherein the conversion unit accommodates a driving control circuit board of the LED.

8. The illumination device of claim 6, wherein the conversion unit comprises an electrical conductive connector having a screw thread.

9. The illumination device of claim 4, wherein a second end of the first electrical conductive body is disposed along the frame and an outer surface of the reflective cover and electrically coupled to a driving control circuit board.

10. The illumination device of claim 4, wherein a second end of the second electrical conductive body is disposed along the frame and an outer surface of the reflective cover and electrically coupled to a driving control circuit board.

11. The illumination device of claim 1, wherein the reflective cover further comprises a plurality of heat fins disposed on an outer surface of the reflective cover.

12. The illumination device of claim 1 further comprising:
a lens disposed adjacent to the LED.
